(19) United States
(12) Patent Application Publication
(10) Pub. No.: US 2014/0195455 A1
(43) Pub. Date: Jul. 10, 2014

(54) ASSET DELIVERY VISUALIZATION SYSTEM AND METHOD

(71) Applicants: Felix LLUBERES, Naples, FL (US); Hong LONG, Naples, FL (US)

(72) Inventors: Felix LLUBERES, Naples, FL (US); Hong LONG, Naples, FL (US)

(73) Assignee: POSITION LOGIC LLC, Naples, FL (US)

(21) Appl. No.: 14/147,148

(22) Filed: Jan. 3, 2014

Related U.S. Application Data
(60) Provisional application No. 61/750,539, filed on Jan. 9, 2013.
(60) Provisional application No. 61/847,817, filed on Jul. 18, 2013.

(51) Int. Cl. G06Q 10/08

(52) U.S. Cl. CPC G06Q 10/0833
USPC 705/333

(57) ABSTRACT

Systems and methods providing asset delivery visualization for validating the transportation and delivery of cargo. Embodiments of the invention provide for the monitoring of a transportation vehicle and an asset being transported by the transportation vehicle during a transport mission. Furthermore, embodiments of the invention allow a customer to view information related to the transport mission on a user device upon delivery of the cargo to the customer, helping the customer to decide whether to accept or reject the cargo.

This U.S. Patent Application claims the benefit of and the priority to provisional U.S. Patent Application Ser. No. 61/750,539 filed on Jan. 9, 2013, and provisional U.S. Patent Application Ser. No. 61/847,817 filed on Jul. 18, 2013.

### BACKGROUND

1. Technical Field

The subject matter disclosed herein relates to asset delivery. In particular, the subject matter disclosed herein relates to asset delivery visualization systems and methods for validating the transportation and delivery of cargo.

2. Discussion of Art

When an asset (cargo) is transported from a point of origination to a point of destination in a transportation vehicle, there may be certain rules that are to be followed and certain criteria that are to be met during the transportation process. For, example, the driver of the transportation vehicle may be required to follow a determined route, and the cargo may be required to be kept under determined environmental conditions (e.g., temperature, humidity, stability, shock, vibration, etc.). However, once the cargo is delivered, the recipient of the cargo may not have the proper information to know whether to accept or reject the cargo based on whether or not the rules have been followed and the criteria have been met.

### BRIEF DESCRIPTION

In one embodiment, a system is provided that includes a user device configured to aid a user in accepting or rejecting an asset upon delivery by, at least in part, scanning encoded information on a delivery order associated with the asset; at least one on-board monitoring system configured to be installed in a transportation vehicle and monitor aspects of the transportation vehicle and characteristics of an asset being transported by the transportation vehicle during a transport mission, and output encoded information to be put on the delivery order; and a transportation monitoring system configured to receive monitored information from the on-board monitoring system, process the monitored information, and provide access of the processed information to the user device based on the encoded information. The transportation monitoring system may include a server computer and a database. The at least one on-board monitoring system may include a printing device configured to print the encoded information onto one or more of the delivery order or a tag. The at least one on-board monitoring system may include one or more of a global positioning system receiver, environmental monitoring devices, a vehicle data interface device, a data capture module, and a transmitter device.

In one embodiment, a user device is provided that includes a display screen; a scanner configured to read encoded information on a code or tag printed on or affixed to a delivery order associated with a monitored transport mission transporting an asset; a processing device; and an asset delivery visualization software application configured to run on the processing device and use the encoded information to facilitate the access and displaying of information associated with the monitored transport mission on the display screen, helping the customer to decide whether to accept or reject the delivered asset. The user device may include a user interface configured to enable a customer to operate and interact with the user device. The user device may include a wireless communication device configured to communicate through a wireless data communication infrastructure. The user device may be a mobile hand-held device.

In one embodiment, a method is provided. The method includes monitoring one or more of aspects of a transportation vehicle or characteristics of an asset as the vehicle transports the asset during a transport mission; recording, locally and/or remotely, monitored data associated with the monitored aspects and characteristics; and printing a code on or affixing a tag to a delivery order associated with the transport mission upon delivery of the asset, where the code or tag is encoded with scannable information related to one or more of the monitored vehicle or asset. The monitored data associated with the monitored aspects and characteristics may be transmitted to a remotely located transportation monitoring system for recording. The scannable information may include at least a portion of the monitored data. The scannable information may include information to direct a customer to a web page provided by a remotely located transportation monitoring system.

In one embodiment, a method is provided. The method includes scanning one of a code or tag printed on or affixed to a delivery order associated with a monitored transport mission, using a user device, to read encoded information on the code or tag; displaying the encoded information on a display screen of the user device and/or automatically directing the user device to access a transportation management system having information related to the monitored transport mission, in response to reading the encoded information; and acknowledging acceptance or rejection of an asset delivered as part of the transport mission using a user interface of the user device. The method may include selecting a displayed category, associated with the encoded information or the information related to the monitored transport mission, using a user interface of the user device to access detailed information associated with the displayed category. The displayed category may be associated with one of a shipping route, environmental criteria, a designated driver, a transport vehicle type, a total shipping time, and safety limits The method may include formatting the detailed information for display on a display screen of the user device.

In one embodiment, a non-transitory computer readable medium is provided having computer executable instructions of an asset delivery visualization software application recorded thereon. The computer executable instructions are configured to be executed by a hand-held processing and communication device to provide asset delivery visualization to a recipient of a shipped asset. The instructions may include instructions for facilitating the scanning of a printed medium or an affixed tag having encoded information associated with a monitored transport mission; instructions for one or more of displaying the encoded information or directing to a web page having information related to the monitored transport mission based on the encoded information; and instructions for facilitating the acknowledging of the acceptance of or the rejection of an asset delivered as part of the transport mission. The instruction may include instructions for formatting the encoded information for display. The instructions may include instructions for accessing and displaying the web page. The instructions may include instructions for facilitating one or more of transmitting information to a remote transportation monitoring system or receiving information from a remote transportation monitoring system.

### BRIEF DESCRIPTION OF THE DRAWINGS

Reference is made to the accompanying drawings in which particular embodiments of the invention are illustrated as described in more detail in the description below, in which:

FIG. 1 is a schematic block diagram of an exemplary embodiment of a system for providing transport monitoring and asset delivery visualization;

FIG. 2 is a schematic block diagram of an exemplary embodiment of a user device of the system of FIG. 1;

FIG. 3 is a schematic block diagram of an exemplary embodiment of a transportation management system of the system of FIG. 1;

FIG. 4 is a schematic block diagram of an exemplary embodiment of an on-board monitoring system of the system of FIG. 1;

FIG. 5 is a flowchart of an exemplary embodiment of a method for providing transport monitoring using at least a portion of the system of FIG. 1;

FIG. 6 is a flowchart of an exemplary embodiment of a method for providing asset delivery visualization using at least a portion of the system of FIG. 1;

FIG. 7 illustrates an exemplary embodiment of a displayed representation of monitored transport mission information using at least a portion of the system of FIG. 1; and

FIG. 8 illustrates a diagram of an exemplary embodiment of a computerized eyewear device serving as a user device.

### DETAILED DESCRIPTION

A customer of an asset (cargo) to be delivered to the customer may desire information upon delivery of the asset that allows the customer to make an informed decision about whether to accept or reject the asset upon delivery. Embodiments of the invention relate to methods and systems providing transport monitoring and asset delivery visualization.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing element” or “computer device” or “processor” as used herein includes, but is not limited to, any programmed or programmable electronic device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. “Controller”, as used herein, refers to the logic circuitry and/or processing elements and associated software or programs involved in providing transportation monitoring and/or asset delivery visualization. The terms “signal”, “data”, and “information” may be used interchangeably herein and may refer to digital or analog forms. The term “communication device” as used herein may refer to any wired or wireless device (e.g., a computer modem) operable to receive and/or transmit signals, data, or information. The term “communication infrastructure” as used herein may refer to any or all of the systems involved in providing the communication of information between two or more devices (e.g., a cellular telephone system, the internet, a satellite communication system). The term “user interface” as used herein may refer to any and all types of hardware and/or software that allow a user to interact with a device (e.g., a keypad, a keyboard, a touch-screen, a computer mouse, a voice-activated system). The term “scanning device” as used herein may refer to a device configured to read encoded data (e.g., bar code data or RFID data) for use by a computer device. “RFID” refers to radio frequency identification. For example, a scanning device may be an optical imaging device or a near-field communication device. The terms “cargo” and “asset” may be used interchangeably herein.

The term “head up display (HUD)”, as used herein, refers to a transparent display that presents information that is viewable to a user without requiring the user to look away from a currently desired viewpoint.

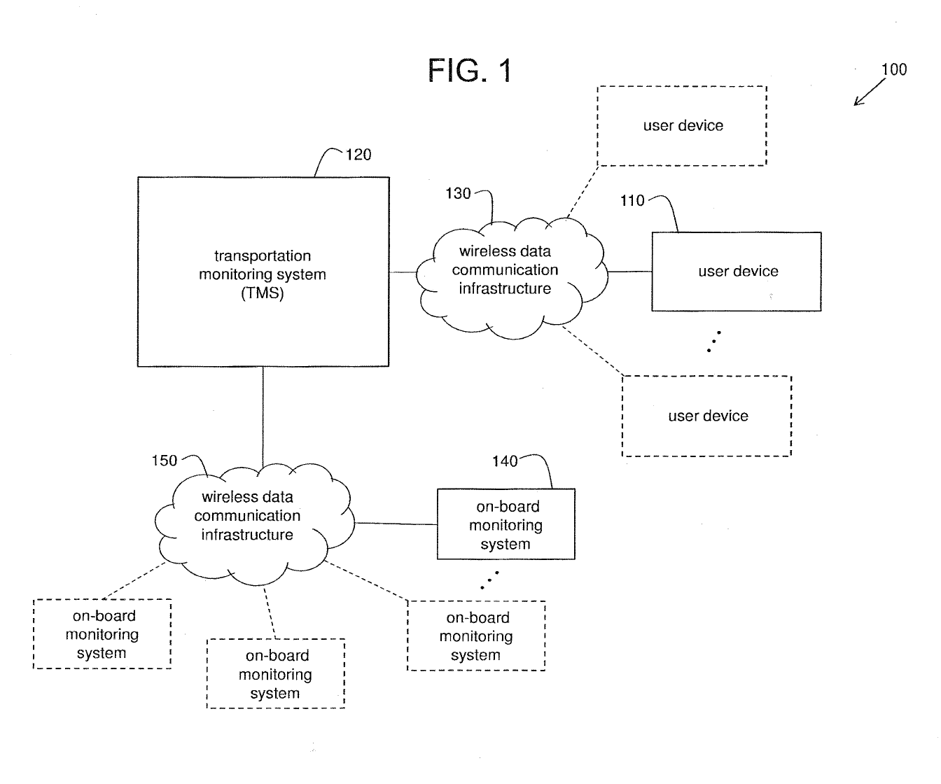

FIG. 1 is a schematic block diagram of an exemplary embodiment of a system 100 for providing transport monitoring and asset delivery visualization. The system 100 provides a customer with visualization of information associated with a transport mission and an asset that is delivered to the customer as part of the transport mission. An asset may be any product or commodity that is deliverable to a customer via a transportation vehicle. In accordance with an embodiment, various aspects of the transportation vehicle/driver are monitored during the transport mission. Furthermore, various characteristics of the asset may also be monitored during the transport mission.

The system 100 includes one or more user devices 110, a transportation monitoring system (TMS) 120, and a wireless data communication infrastructure 130. The wireless data communication infrastructure 130 provides wireless communication between the user device 110 and the TMS 120. The wireless data communication infrastructure 130 may be in the form of a cellular telephone network, a satellite communication network, or some other wireless network, in accordance with various embodiments.

The system 100 also includes one or more on-board monitoring systems 140. In accordance with an embodiment, an on-board monitoring system 140 may be installed in a transportation vehicle and is configured to provide monitoring of aspects of the transportation vehicle (including driver-initiated actions) and/or characteristics of an asset being transported by the transportation vehicle during a transport mission. The system also includes a wireless data communication infrastructure 150 providing communication between the TMS 120 and the on-board monitoring systems 140. The wireless data communication infrastructure 130 may be in the form of a cellular telephone network, a satellite communication network, or some other wireless network, in accordance with various embodiments.

In accordance with an embodiment, a customer may take delivery of an asset (cargo), that was transported by a transportation vehicle having an on-board monitoring system 140 during a transport mission, and employ the user device 110 upon delivery to validate the conditions under which the asset was transported. For example, the customer may employ the user device 110 to confirm that appropriate transportation rules were followed during the transport mission and that certain criteria were met during the transportation process. Verifying such rules and criteria may include determining the identity of the driver of the transportation vehicle, the route taken by the transportation vehicle, the amount of time the transportation vehicle was en route during the transport mission, the maximum speed of the transportation vehicle during the transport mission, and the temperature and humidity of the environment within the transportation vehicle containing the asset during the transport mission. Other rules and criteria may be possible to verify as well, in accordance with various embodiments.

The customer (user) may accept or reject delivery of the asset based on the verification results. For example, if the customer determines that the asset was not kept at the proper temperature throughout the transport mission, the customer may reject delivery of the asset. In accordance with an embodiment, the customer may use the user device 110 to formally accept or reject the asset.

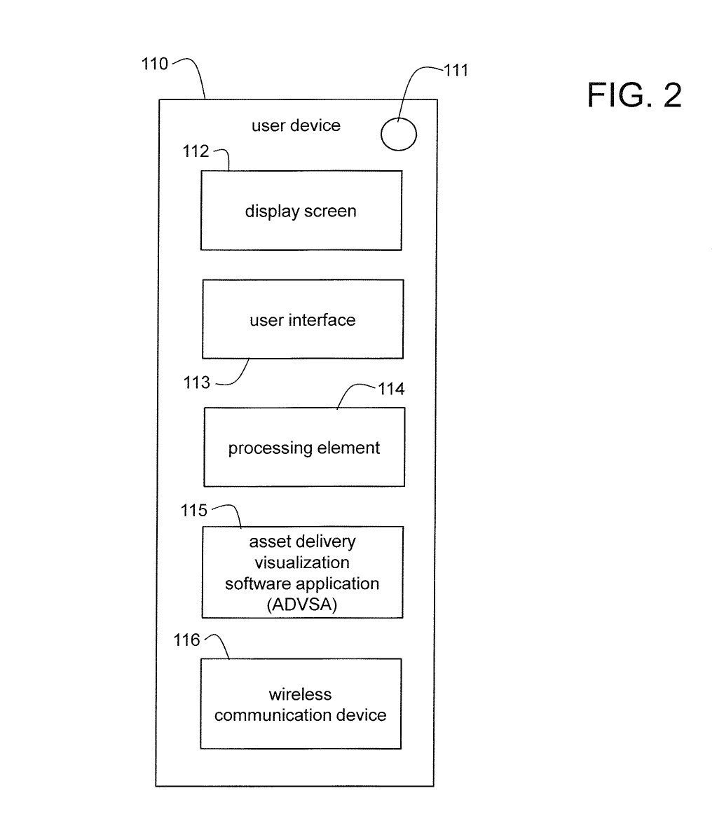

FIG. 2 is a schematic block diagram of an exemplary embodiment of a user device 110 of the system 100 of FIG. 1. The user device 110 includes a scanning device 111 (e.g., an optical scanning device or an RFID reader), a display screen 112, a user interface 113, a processing element 114, and an asset delivery visualization software application (ADVSA) 115 configured to run on the processing element 114. In some embodiments, the user device 110 may include one or more processing elements 114 (e.g., microprocessors) for executing the ADVSA, the operating system of the user device, or other software of the user device.

In accordance with an embodiment, the user device 110 may be a mobile, hand-held device such as a cellular telephone or a tablet computer device that is configured to wirelessly access the wireless data communication infrastructure 130.

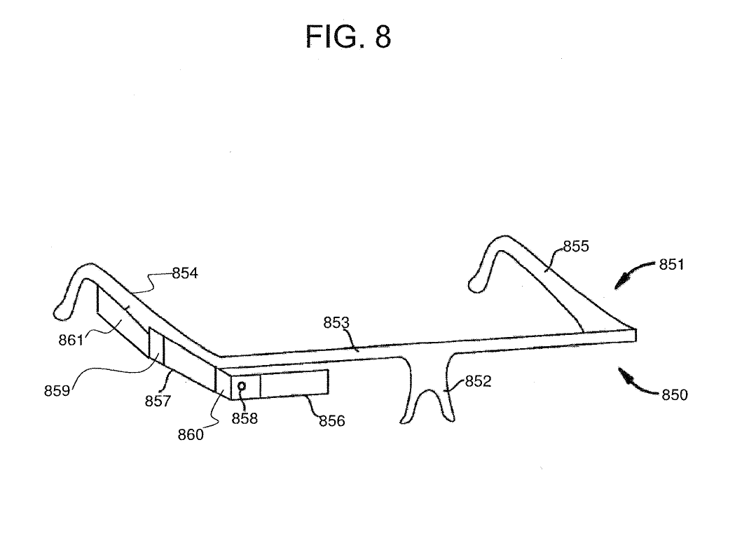

For example, the user device 110 may include a wireless communication device 116 for communicating through the wireless data communication infrastructure 130. In accordance with another embodiment, the user device 110 may be a computerized eyewear device, as described herein with respect to FIG. 8. In accordance with an embodiment, the asset delivery visualization software application (ADVSA) 115 may be recorded on a non-transitory computer-readable medium for distribution, for example.

A customer, using the user device 110, may launch the ADVSA 115 on the user device 110 using the user interface 113. The user interface 113 may be, for example, a touch-screen or a keypad. The scanning device 111 is configured to scan and read encoded information from a code printed on (or a tag affixed to) a delivery order associated with a transport mission. The ADVSA 115 may be configured to process the scanned information and display the scanned information on the display screen 112, in accordance with an embodiment, where the scanned information includes information associated with the monitored transport mission. The ADVSA 115 executes on the processing element 114 which may be, for example, a microprocessor device.

Furthermore, the ADVSA 115 may be configured to allow the user device 110 to access a web page (via the wireless data communication infrastructure 130) provided by the TMS 120 as directed by the scanned information. The web page may be configured to provide information associated with the monitored transport mission to the user device 110 which may be viewed by the customer on the display screen 112. Alternatively, the ADVSA 115 may be configured to allow the user device 110 to access information from the TMS 120 that is associated with a transport mission correlated to the scanned information, and display the accessed information on the display screen 112. That is, the software application 115 provides access to the information from the TMS via the user device and configures the information for display on the user device.

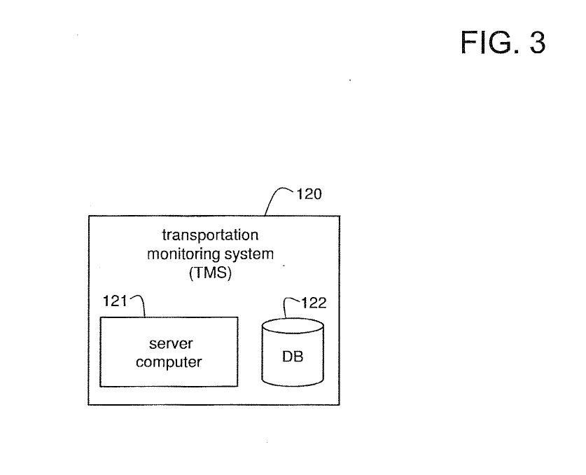

FIG. 3 is a schematic block diagram of an exemplary embodiment of a transportation management system (TMS) 120 of the system 100 of FIG. 1. The TMS 120 is configured to receive monitored information from the one or more on-board monitoring systems 140 via the wireless data communication infrastructure 150, and configure the received information into a form that is accessible and useable by customers (e.g., a web page). In accordance with an embodiment, the TMS 120 includes one or more server computers 121 and at least one database 122. The server computers 121 are configured to communicate with the on-board monitoring systems 140 and the user devices 110 and to store monitored data in the database 122. The TMS 120 may configure the monitored data in the form of a web page for access by customers. In accordance with an embodiment, the TMS 120 is located remotely from the user devices 110 (which are located at customer locations) and the on-board monitoring systems 140 (which are installed in transportation vehicles). For example, the TMS 120 may be located at a service center of a transportation company.

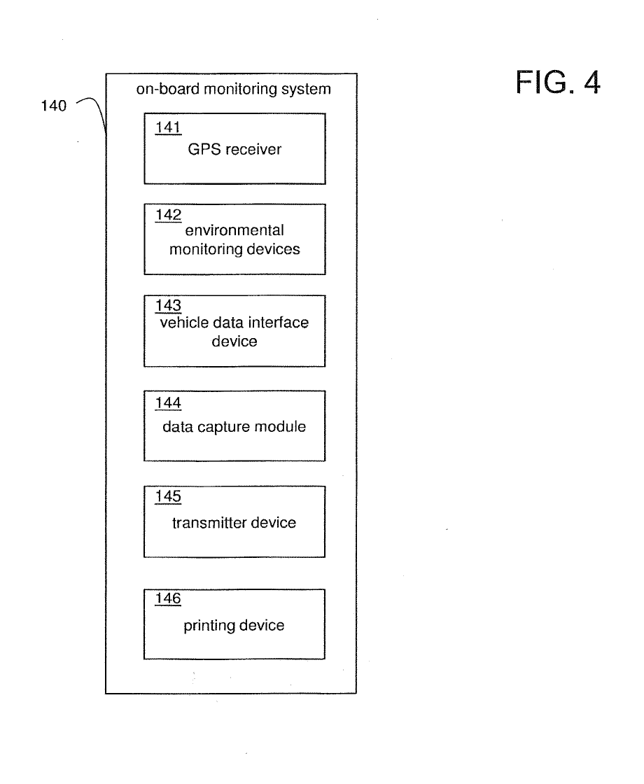

FIG. 4 is a schematic block diagram of an exemplary embodiment of an on-board monitoring system 140 of the system 100 of FIG. 1. The on-board monitoring system 140 is configured to be installed on a transportation vehicle such as, for example, a truck. The on-board monitoring system 140 includes a global positioning system (GPS) receiver 141 configured to monitor the location of the transportation vehicle during a transport mission. The on-board monitoring system 140 may also include environmental monitoring devices 142 such as, for example, temperature sensors and humidity sensors configured to monitor the temperature and humidity of the environment within the transportation vehicle containing the asset (cargo) being transported. Other sensors may be employed as well such as, for example, shock and vibration sensors or accelerometers.

The on-board monitoring system 140 may also include a vehicle data interface device 143 configured to interface to a data system of the transportation vehicle to receive vehicle data related to, for example, the speed of the transportation vehicle and levels of acceleration and deceleration of the transportation vehicle during a transport mission. Data related to other types of vehicle parameters may be received as well by the vehicle data interface device 143, in accordance with various embodiments.

The on-board monitoring system 140 may also include a data capture module 144 configured to capture and encode or format data from the GPS receiver 141, the environmental monitoring devices 142, and the vehicle data interface device 143 and provide the encoded/formatted data to a transmitter device 145 or a printing device 146 of the on-board monitoring system 140. In accordance with an embodiment, the transmitter device 145 is configured to wirelessly transmit the formatted, monitored data to the TMS 120 via the wireless data communication infrastructure 150. The TMS 120 is configured to receive the data transmitted by the on-board monitoring device 140 and store the data in the database 122. The stored data is associated with a transport mission in the database such that the data may be readily accessed by a customer at the end of the transport mission upon delivery of an asset that was transported during the transport mission. The printing device 146 may be configured to print encoded information directly onto a delivery order or onto a tag to be affixed to a delivery order. In accordance with another embodiment, the printing device 146 may be configured to encode an RFID tag with data related to the transport mission.

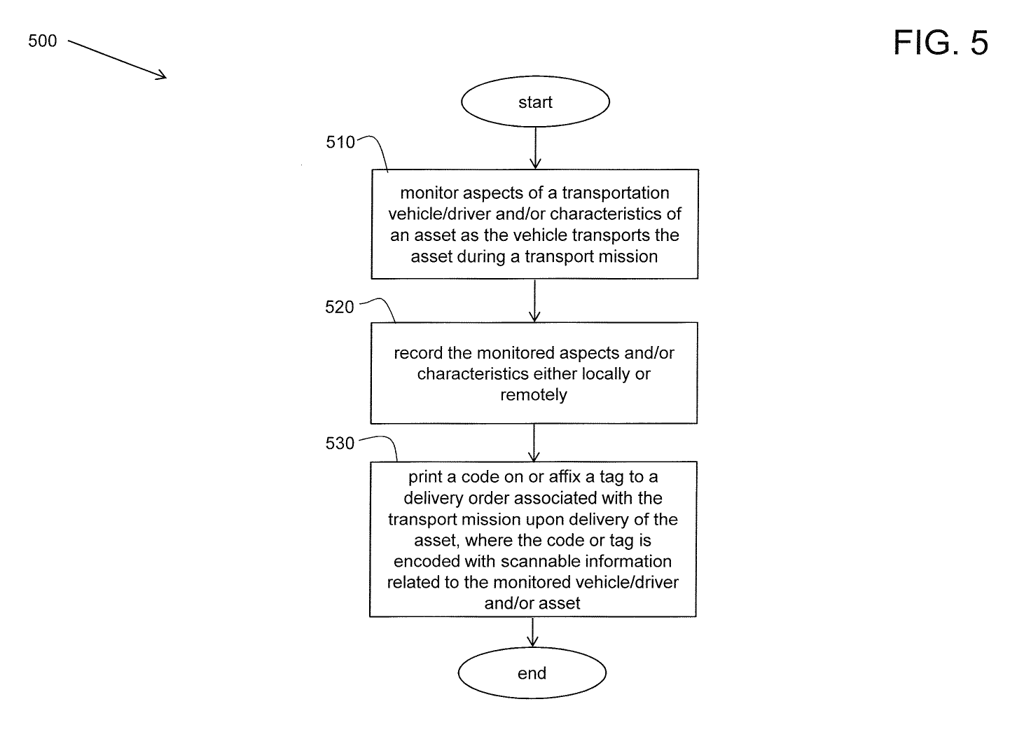

FIG. 5 is a flowchart of an exemplary embodiment of a method 500 for providing transport monitoring using at least a portion of the system 100 of FIG. 1. In step 510 of the method 500, aspects of a transportation vehicle/driver and/or characteristics of an asset are monitored as the vehicle transports the asset during a transport mission. For example, the transportation vehicle may have an on-board monitoring system 140 installed which is used to capture and store and/or transmit data associated with the aspects of the transportation vehicle/driver and/or characteristics of the asset. Aspects of the transportation vehicle/driver may include but are not limited to the speed of the transportation vehicle and levels of acceleration and deceleration of the transportation vehicle during a transport mission, or a route taken by the transportation vehicle during the transport mission. Characteristics of the asset may include but are not limited to environmental conditions experienced by the asset during the transport mission (e.g., temperature, humidity, vibration, shock, light).

In step 520, data corresponding to the monitored aspects and/or characteristics are recorded either locally by the on-board monitoring system 140 (e.g., in a memory storage device of the on-board monitoring system) or remotely (e.g., at the TMS 120 in the database 122). As discussed herein, the on-board monitoring system 140 may communicate data to the TMS 120 via the wireless data communication infrastructure 150.

In step 530, a code is printed onto a delivery order (or a tag is affixed to the delivery order) associated with the transport mission upon delivery of the asset. In accordance with an embodiment, the delivery order is a piece of paper provided to the customer by the driver of the transportation vehicle at the end of the transport mission. Other forms of a delivery order are possible as well, in accordance with other embodiments. The code (or tag) is encoded with scannable information related to the monitored vehicle and/or asset. The encoded information may be as simple as an identifier which identifies the transport mission, or as complex as a complete summary of the monitored aspects and/or characteristics. The encoded information may include a web page address for accessing a web page associated with the transport mission. The encoded information may be printed directly onto the delivery order or onto a tag to be affixed to the delivery order via the printing device 146 of the on-board monitoring system 140, or encoded into a RFID tag.

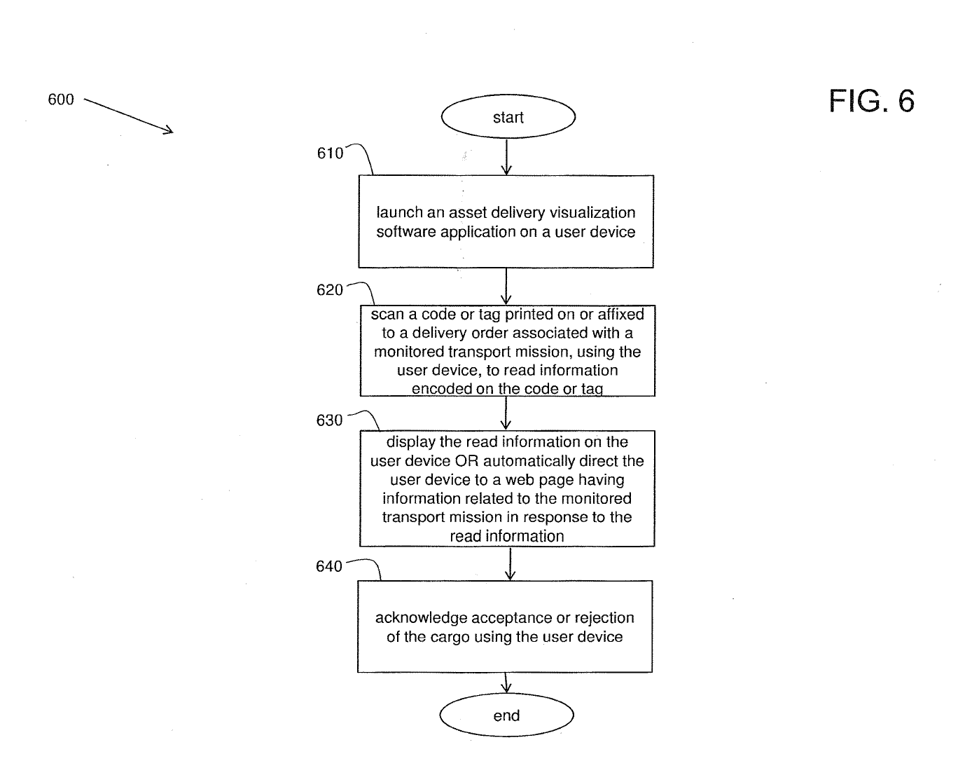

FIG. 6 is a flowchart of an exemplary embodiment of a method 600 for providing asset delivery visualization using at least a portion of the system 100 of FIG. 1. In step 610 of the method 600, an asset delivery visualization software application (ADVSA) is launched on a user device. For example, referring to FIG. 2, a user (customer) may launch the ADVSA 115 on the user device 110 using the user interface 113 and/or display screen 112.

In step 620, a code or tag printed on or affixed to a delivery order associated with a monitored transport mission is scanned, using the user device, to read information encoded on the code or tag. For example, referring to FIG. 2, the user (customer) may position the user device 110 with respect to the delivery order to optically scan the code or tag using the scanning device 111. The encoded information may be as simple as an identifier which identifies the transport mission, or as complex as a complete summary of the monitored aspects and/or characteristics of the transport mission. Furthermore, the encoded information may include a web page address for accessing a web page associated with the transport mission.

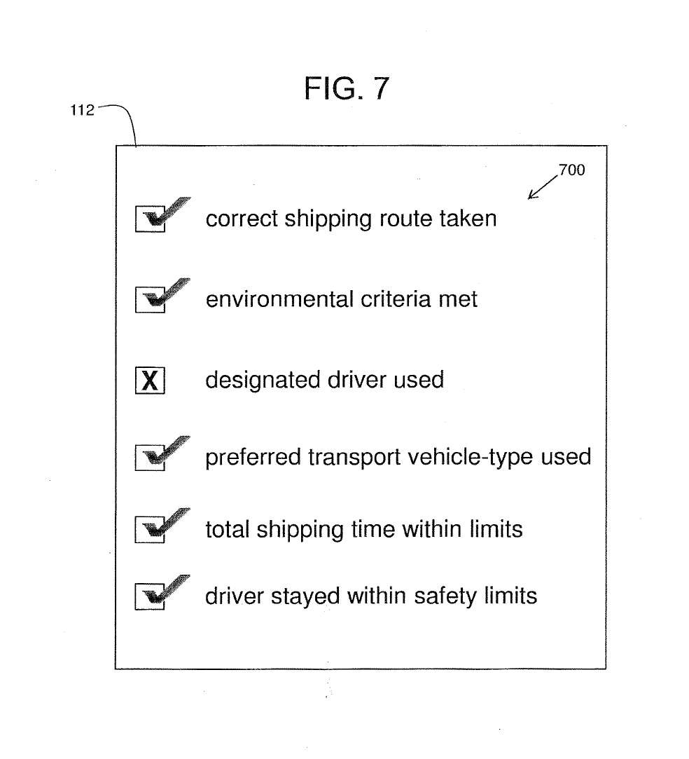

In step 630, the read information is displayed on the user device or automatically directs the user device to a web page having information related to the monitored transport mission. For example, FIG. 7 illustrates an exemplary embodiment of a displayed representation 700 of monitored transport mission information using at least a portion of the system 100 of FIG. 1. The summarized information may be encoded on the code or tag and the ADVSA 115 may format and display the scanned information on the display screen 112 of the user device 110 as shown in FIG. 7. Alternatively, the encoded information may direct the ADVSA 115 to access a web page provided by the TMS 120 that shows the summarized information.

In step 640, upon reviewing the information associated with the transport mission on the user device, the user (customer) may acknowledge acceptance or rejection of the cargo using the user device. For example, referring to FIG. 7, the summarized information shows six categories of information related to the transport mission (e.g., rules to be followed and criteria to be met). Five of the categories have a check mark indicators, indicating that the correct shipping route was taken, the environmental criteria were met, the preferred transportation vehicle type was used, the total shipping time was within limits, and the driver stayed within the safety limits However, one category has an “X” indicator, indicating that the driver that was designated to drive the transportation vehicle was not used (i.e., a substitute driver was used). In accordance with various other embodiments, indicators other than check marks and “X's” may be used.

The driving history of the substitute driver may be accessed by selecting the “designated driver used” text or the “X” on the display screen 112, in accordance with an embodiment. The driving history of a driver may include various information including, for example, any driving tickets or violations cited against the driver. Monitored transport missions for a particular driver may be used to create a driving record/history for the driver which may be used to certify the driver, for example, to drive for a transportation company. In general, the user may select any of the displayed categories to access more detailed information associated with a category (e.g., select “correct shipping route taken” to access and display a map of the actual route taken).

Upon delivery of the asset to the customer, the customer can view the information of FIG. 7 on the user device 110, as described above and, based on the review, elect to accept or reject the delivered asset. For example, since the driver that was supposed to be used was not used, the customer, upon reviewing the history of the substitute driver, may view this as a reason to reject the asset. The customer may acknowledge acceptance or rejection via the user interface 113 of the user device. Acceptance or rejection information may be communicated from the user device 110 to the TMS 120 via the wireless data communication infrastructure 130 and associated with the transport mission in the database 122, for example.

In accordance with an embodiment, the TMS 120 processes and formats information received from an on-board monitoring device 140 to generate the summary information shown in FIG. 7. Alternatively, the data capture module 144 of the on-board monitoring system 140 processes and formats the monitored information to generate the summary information shown in FIG. 7. In either case, however, the ADVSA 115 of the user device may format the summary information of FIG. 7 for display on the display screen 112 of the user device 110.

FIG. 8 illustrates a diagram of an exemplary embodiment of a computerized eyewear device 850 serving as the user device 110. The computerized eyewear device 850 includes the elements of the user device 110 of FIG. 2, but in the configuration of user eyewear. The computerized eyewear device 850 includes a frame 851 configured to be worn on the head of a user. The frame 851 includes a bridge 852 configured to be supported on the nose of the user and a brow portion 853 coupled to and extending away from the bridge 852 to first and second ends remote therefrom and configured to be positioned over the brows of the user.

The frame also includes a first arm 854 having a first end coupled to the first end of the brow portion 853 and extending to a free end, the first arm being configured to be positioned over a first temple of the user with the free end disposed near a first ear of the user. The frame 851 also includes a second arm 855 having a first end coupled to the second end of the brow portion 853 and extending to a free end, the second arm being configured to be positioned over a second temple of the user with the free end disposed near a second ear of the user. The bridge 852 may be adjustable for selective positioning of the brow portion 853 relative to the eyes of the user, in accordance with an embodiment.

The computerized eyewear device 850 includes a transparent display (e.g., a HUD) 856 affixed to the frame 851, where the HUD 856 corresponds to the display screen 112 of the user device 110. The HUD 856 may be movable with respect to the frame 851 through rotation about a first axis that extends parallel to the brow portion 853, in accordance with an embodiment.

The computerized eyewear device 850 also includes control and communication circuitry (e.g., a computer) 857 enclosed in a housing and affixed to the frame 851, where the computer 857 corresponds to at least the processing element 114 of the user device 110. The control and communication circuitry 857 may include a processing element and memory, for example. The memory may be coupled to the processing element and store software (e.g., the ADVSA 115) that can be accessed and executed by the processing element. The processing element may be a microprocessor or a digital signal processor, for example.

The computerized eyewear device 850 may include a camera or scanning device 858, where the camera or scanning device 858 corresponds to the scanning device 111 of the user device 110. The HUD 856, the control and communication circuitry 857, and the camera or scanning device 858 are operatively connected to provide the functionality described herein. In accordance with an embodiment, the camera or scanning device 858 is configured to scan encoded information on a delivery order as previously described herein with respect to the scanning device 111. The HUD 856 is configured to display information obtained from the scanned delivery order as previously described herein with respect to the display screen 112.

In accordance with an embodiment, the control and communication circuitry 857 provides two-way communication with the TMS 120 through the wireless data communication infrastructure 130. Information may be provided from the TMS 120 to the computerized eyewear device 850 and displayed on the HUD 856. Furthermore, in accordance with an embodiment, the control and communication circuitry 857 is configured to accept voice-activated commands from a user and transmit the commands to the TMS 120. Communication between the TMS 120 and the computerized eyewear device 850 may be accomplished by way of, for example, Bluetooth® radio technology, communication protocols described in IEEE 802.11 (including any IEEE 802.11 revisions), cellular technology (such as GSM, CDMA, UMTS, EVDO, WiMax, or LTE), or ZigBee® technology, among other possibilities. In accordance with an embodiment, the computerized eyewear device may also include optical lenses that match a user's prescription. In accordance with a further embodiment, the computerized eyewear device may be modular and attachable to normal prescription or non-prescription eye glasses.

Furthermore, in accordance with an embodiment, the TMS 120 may be accessible by the computerized eyewear device 850 via the Internet. For example, the control and communication circuitry 857 may be configured to access the Internet through a wireless hot spot (e.g., a smart phone or a wireless router) and access the TMS 120 therethrough. Alternatively, the TMS 120 may be configured to access the Internet and provide information obtained from the Internet to the computerized eyewear device 850. Information that may be displayed on the HUD 856 during delivery of an asset that may be useful to a user may be in the form of text, an image, or a graphic.

In accordance with an embodiment, the computerized eyewear device 850 includes a user interface 859 in the form of a microphone for receiving voice-activated commands from a user, where the microphone 859 corresponds to the user interface 113 of the user device 111. The voice-activated commands, as initiated by a user, that may be accommodated by the computerized eyewear device 850 in communication with the TMS 120 may include, for example, commands to access a web page or commands to access particular information associated with a particular delivery. Other types of commands may be possible as well, in accordance with other embodiments. In accordance with other embodiments, the user interface 859 may be in the form of a touch-screen or a keypad, for example.

With reference to the drawings, like reference numerals designate identical or corresponding parts throughout the several views. However, the inclusion of like elements in different views does not mean a given embodiment necessarily includes such elements or that all embodiments of the invention include such elements.

In the specification and claims, reference will be made to a number of terms have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

The terms “including” and “having” are used as the plain language equivalents of the term “comprising”; the term “in which” is equivalent to “wherein.” Moreover, the terms “first,” “second,” “third,” “upper,” “lower,” “bottom,” “top,” etc. are used merely as labels, and are not intended to impose numerical or positional requirements on their objects. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

This written description uses examples to disclose the invention, including the best mode, and also to enable one of ordinary skill in the art to practice the invention, including making and using any devices or systems and performing any incorporated methods. The embodiments described herein are examples of articles, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes articles, systems and methods that do not differ from the literal language of the claims, and further includes other articles, systems and methods with insubstantial differences from the literal language of the claims. While only certain features and embodiments have been illustrated and described herein, many modifications and changes may occur to one of ordinary skill in the relevant art.

What is claimed is:

1. A system for providing asset delivery visualization comprising:
a user device configured to aid a user in accepting or rejecting an asset upon delivery by, at least in part, scanning encoded information on a delivery order associated with the asset;
at least one on-board monitoring system configured to be installed in a transportation vehicle and monitor aspects of the transportation vehicle and characteristics of an asset being transported by the transportation vehicle during a transport mission, and output encoded information to be put on the delivery order; and
a transportation monitoring system configured to receive monitored information from the on-board monitoring system, process the monitored information, and provide access of the processed information to the user device based on the encoded information.

2. The system of claim 1, wherein the transportation monitoring system includes a server computer and a database.

3. The system of claim 1, wherein the at least one on-board monitoring system includes a printing device configured to print the encoded information onto one or more of the delivery order or a tag.

4. The system of claim 1, wherein the at least one on-board monitoring system includes one or more of a global positioning system receiver, environmental monitoring devices, a vehicle data interface device, a data capture module, and a transmitter device.

5. A user device for providing asset delivery visualization to a customer upon delivery of an asset, the user device comprising:
a display screen;
a scanner configured to read encoded information on a code or tag printed on or affixed to a delivery order associated with a monitored transport mission transporting an asset;
a processing device; and
an asset delivery visualization software application configured to run on the processing device and use the encoded information to facilitate the access and displaying of information associated with the monitored transport mission on the display screen, helping the customer to decide whether to accept or reject the delivered asset.

6. The user device of claim 5, further comprising a user interface configured to enable a customer to operate and interact with the user device.

7. The user device of claim 5, further comprising a wireless communication device configured to communicate through a wireless data communication infrastructure.

8. The user device of claim 5, wherein the user device is a mobile hand-held device.

9. A method for providing asset delivery visualization to a customer upon delivery of an asset, the method comprising:
monitoring one or more of aspects of a transportation vehicle or characteristics of an asset as the vehicle transports the asset during a transport mission;
recording, at least one of locally or remotely, monitored data associated with the monitored aspects and characteristics; and
printing a code on or affixing a tag to a delivery order associated with the transport mission upon delivery of the asset, where the code or tag is encoded with scannable information related to one or more of the monitored vehicle or asset.

10. The method of claim 9, wherein the monitored data associated with the monitored aspects and characteristics is transmitted to a remotely located transportation monitoring system for recording.

11. The method of claim 9, wherein the scannable information includes at least a portion of the monitored data.

12. The method of claim 9, wherein the scannable information includes information to direct a customer to a web page provided by a remotely located transportation monitoring system.

13. A method for providing asset delivery visualization to a customer upon delivery of an asset, the method comprising:
scanning one of a code or tag printed on or affixed to a delivery order associated with a monitored transport mission, using a user device, to read encoded information on the code or tag;
one or more of displaying the encoded information on a display screen of the user device or automatically directing the user device to access a transportation management system having information related to the monitored transport mission, in response to reading the encoded information; and
acknowledging acceptance or rejection of an asset delivered as part of the transport mission using a user interface of the user device.

14. The method of claim 13, further comprising selecting a displayed category, associated with the encoded information or the information related to the monitored transport mission, using a user interface of the user device to access detailed information associated with the displayed category.

15. The method of claim 14, wherein the displayed category is associated with one of a shipping route, environmental criteria, a designated driver, a transport vehicle type, a total shipping time, and safety limits

16. The method of claim 14, further comprising formatting the detailed information for display on a display screen of the user device.

17. A non-transitory computer-readable medium having computer executable instructions of an asset delivery visualization software application (ADVSA) recorded thereon, wherein the computer executable instructions are configured to be executed by a hand-held processing and communication device to provide asset delivery visualization to a recipient of a shipped asset, and wherein the instructions include:
instructions for facilitating the scanning of a printed medium or an affixed tag having encoded information associated with a monitored transport mission;
instructions for one or more of displaying the encoded information or directing to a web page having information related to the monitored transport mission based on the encoded information; and
instructions for facilitating the acknowledging of the acceptance of or the rejection of an asset delivered as part of the transport mission.

18. The non-transitory computer-readable medium of claim 17, wherein the instructions further include instructions for formatting the encoded information for display.

19. The non-transitory computer-readable medium of claim 17, wherein the instructions further include instructions for accessing and displaying the web page.

20. The non-transitory computer-readable medium of claim 17, wherein the instructions further include instructions for facilitating one or more of transmitting information to a remote transportation monitoring system or receiving information from a remote transportation monitoring system.
